(19) United States
(12) Patent Application Publication
(10) Pub. No.: US 2007/0274682 A1
(43) Pub. Date: Nov. 29, 2007

(54) Image processing apparatus

(75) Inventors: Toshiya Mizushima, Yokohama (JP); Keiji Nagayama, Yokohama (JP); Masahiro Fujimoto, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/715,528

(22) Filed: Mar. 7, 2007

(30) Foreign Application Priority Data
May 25, 2006 (JP) 2006-144759

(51) Int. Cl. H04N 5/91

(52) U.S. Cl. 386/95

(57) ABSTRACT

An image processing apparatus, comprising: a reproducing portion, which is configured to reproduce a picture compressed with a first format; an obtain instructing portion, which is configured to instruct an obtaining of the picture reproduced by the reproducing portion; and a recording portion, which is configured to record the picture, obtaining of which is instructed by the instructing portion, wherein the recording portion determines on presence of a picture, which is compressed with a second format corresponding to the picture instructed by the instructing portion, and wherein it records the picture corresponding thereto, which is compressed with the second format, when determining it is, or records the picture instructed, by compressing it with the second format, when determining it is not.

### BACKGROUND OF THE INVENTION

The present invention relates to an image processing apparatus, equipped with a still picture capturing function of taking in or capturing an image under reproduction to be a still picture, and in particular, it relates to a technology for obtaining a high quality picture, in particular, when operating the still picture capturing function during the time when reproducing the still picture.

The still picture capturing function is already known, for capturing an arbitrary one (1) piece of moving picture to be the still picture, to be recorded into a recording medium. This still picture capturing function produces still picture data from the moving picture data under reproduction. As an example of applying this is known in the Patent Document 1. In the Patent Document 1 is described “a still picture capturing apparatus for capturing the moving picture data inputted in the form of the still picture therein, comprising a temporary obtaining portion for capturing the moving picture data therein, always, at a predetermined time interval larger than a digitalizing period thereof, in the form of the still picture, thereby to memorize it therein temporarily, when inputting the moving picture and is displayed, and a capturing instructor portion for inputting an instruction for transferring a plural number of still pictures, which are temporarily memorized in said temporary obtaining portion, into a storage portion, for the purpose of displaying thereof”.

Also, a video recording/reproducing apparatus of recent years has a plural number of photographing modes, such as, enabling to conduct photographing and recording on both the moving picture and the still picture, with one (1) set of the apparatus, etc., and further an advancement is achieved in the multi-functions thereof. As an example of applying this is shown in the Patent Document 2. In this Patent Document 2 is described, for accomplishing an abject “to provide a video recording apparatus, enabling a recordable player upon basis of reproducing MPEG moving picture to reproduce, when reproducing the still picture photographed, thereby being suitable for recording a high definition still picture”, there is the description “within the video recording apparatus, when recording the still picture, recording is made on both the still picture, which is coded by a still picture coding means, and the still picture obtained by coding a signal of one (1) frame, which is produced from the same still picture by a signal converter means within a moving picture coding means”.

Patent Document 1: Japanese Patent Laying-Open No. 2001-54053 (2001); and

Patent Document 2: Japanese Patent Laying-Open No. 2005-51813 (2005).

### BRIEF SUMMARY OF THE INVENTION

The technology disclosed in the Patent Document 1, consideration is made upon the still picture capturing function when reproducing the moving picture. However, there is no description of using the still picture capturing function for the still picture, when reproducing the moving picture and the still picture and so on. Also, though the technology disclosed in the Patent Document 2 takes the reproduction of the moving picture and the still picture with applying the same compression technology (for example, MPEG (Moving Picture Experts Group) method or format) thereon, into the consideration thereof, however there is no description of applying the still picture capturing function onto the still picture when reproducing them.

There may be means for restricting the still picture capturing function to be used only for the moving picture. However, as well as, capturing one (1) scene of the moving picture, there is a need for capturing also one (1) scene, which was originally recorded to be the still picture, i.e., producing so-called an original album. If the use of the still picture capturing function is limited onto to the moving picture, it is difficult for a use to handle, even if enabling to reproduce both the moving picture and the still picture in the similar manner, in accordance with the technology disclosed in the Patent Document 2, etc.

Also in recent years, accompanying with high-density of pixels of an image pickup element, it is possible to obtain the high quality of the still picture photographed by a camera. For example, in case when recording the still picture with JPEG method or format, it is possible to record the picture at high pixel density, such as, (horizontal) 1,600 pixels×(vertical) 1,200 pixels, for example. On the contrary to this, in accordance with MPEG method or format, which can be also applied for the moving picture, it is general that the pixel number is lower than that, which is recorded with JPEG format. For example, for the JPEG format, it is enough to provide (horizontal) 720 pixels×(vertical) 480 pixels, i.e., 400,000 pixels. However, for an apparatus of recording the still picture in resent years, it is common to have several million pixels. For example, if the MPEG format and the JPEG format are same in the pixel number, the still picture obtained with the JPEG format has a high quality. Both the MPEG format and the JPEG format allow picture quality deterioration a little bit, but in general, the JPEG format gives less picture quality deterioration for the still picture.

Then, if it is possible to operate the still picture capturing function, during when reproducing, but not separating the moving picture and the still picture of MPEG format from each other, it is impossible to obtain the still picture having a picture quality exceeding that, which can be obtained with the MPEG format. Thus, there can be considered a problem of capturing the still picture, being lower in picture quality than the still picture, which was recorded with the JPEG format originally, by using the still picture capturing function.

However, in such tendency of obtaining the high quality of the still picture, which is photographed by a camera, as was mentioned above, a high quality is request for the still picture, which is recorded with using the still picture capturing function.

Then, there is provided a recording apparatus, for dealing with a still picture of a second format, as a take-in picture (i.e., a picture of capturing the still picture), for example, when reproducing the moving picture and the still picture of a first format, mixing them up, in particular, when capturing the still picture of this first format by using the still picture capturing function, and if there is a still picture corresponding thereto, being recorded with a second format and having higher picture quality than that of the first format, then taking in the still picture of this second format.

In more details thereof, for example, within a video recording/reproducing apparatus, comprising a recoding medium, recording a first still pictured data compressed with a first compression/expansion format, and/or second still picture data compressed with a second compression/expansion format and moving picture data compressed with the first compression/expansion format, and a reproducing portion for reproducing the first still picture data and the moving picture data recording on the recording medium by expanding them with the first compression/expansion format, there are provided a still picture capturing means for recoding the first still picture data or the moving picture data, which are reproduced from the reproducing means, into a second recording medium, by compressing them with the second compression/expansion format, and a data presence determining means for determining on presence of a second still picture data, which is related to the first till picture data or the moving picture data under reproduction, when recording by a still picture capturing means, wherein in particular, through a predetermined operation by the still picture capturing means, when the first still picture data or the moving picture data under reproduction is recorded, if the data presence determining means determines it is, then a second still picture data on the recording medium is recorded into a second recording medium, and if the data presence determining means determines it is not, then the first still picture data or the moving picture data on the recording medium is recorded into the second recording medium by compressing it with the second compression/expansion format. With this, since the still picture to be taken for recording, during reproduction of the still picture is the still picture data of (horizontal) 1,600 pixels×(vertical) 1,200 pixels, i.e., the pixel number of an original, which is recorded with the JPEG format; therefore, it is possible to improve the picture quality of the still picture, which is taken during the production the still picture, to be recorded, and also, to obtain a still picture, which is converted from the MPEG format into the JPEG format during the reproduction of the moving picture, as well.

With those means mentioned above, it is possible for a user to obtain a high quality picture, by the still picture capturing function.

Other than those mentioned above, other object(s), means, and/or effect(s) achieved by the present invention may be apparent from the embodiment(s), which will be mentioned later.

### BRIEF DESCRIPTION OF THE DRAWING

Those and other features, objects and advantages of the present invention will become more apparent from the following description when taken in conjunction with the accompanying drawings wherein:

FIG. 1 is a block diagram for showing the inner structures of a video camera;

FIG. 2 is a flowchart for showing the operation when recording a moving picture with the video camera;

FIG. 3 shows an example of the data structures when recording the moving picture with the video camera;

FIG. 4 is a flowchart for showing the operation when recording a still picture with the video camera;

FIG. 5 shows an example of the data structures when recording the still picture with the video camera;

FIG. 6 shows an example of a screen for an error display on the video camera;

FIG. 7 is a view for showing a series of flows for predictive coding under MPEG compression method or format; and

FIG. 8 is a flowchart for showing the operation of a still picture capturing function of the video camera.

### DETAILED DESCRIPTION OF PREFERRED EMBODIMENTS

Hereinafter, embodiments according to the present invention will be fully explained by referring to the attached drawings. However, the present embodiment should not be restricted only to the embodiments, which will be shown below.

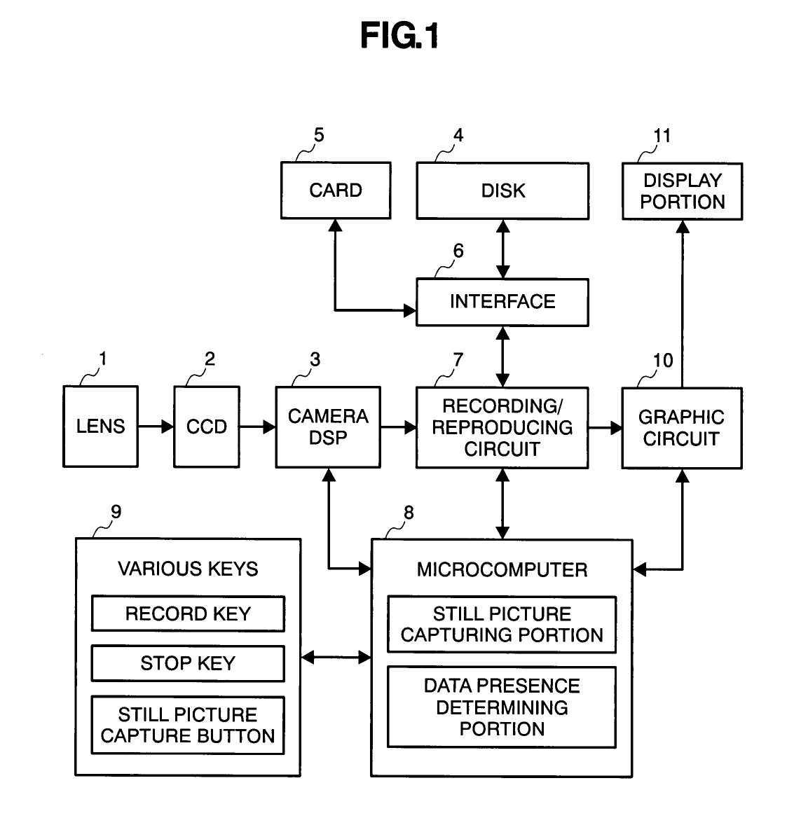

(1) As a video recording/reproducing apparatus according to the present embodiment, explanation will be made on the inner structures and a brief operation of a video camera, by referring to FIG. 1. Other than the video camera, it may be a stationary recorder, or a player for exclusive use of reproducing, for example. Or, it may be called an image processing apparatus.

FIG. 1 is a block diagram for showing the inner structures of the video camera. In this FIG. 1, the present video camera is constructed with a lens 1, a CCD (Charge Coupled Device) 2, as being an image pickup element, a camera DSP (Digital Signal Processor) 3, a disk of a recording medium, such as, an optical disk or a hard disk, etc., recording video data to be an origin of reproduction, a card of a recording medium, as a second recording medium, as an objective or a destination of recording still picture data, an interface 6 for writing/reading of the data between the disk 4 and the card 5, a recording/reproducing circuit 7 for compressing a record video signal with two (2) kinds of compression methods (i.e., MPEG format and JPEG format), and for expanding the image data of the disk 4 to reproduce, a microcomputer 8 for controlling the entire of the present video camera, as well as, building up a still picture capturing portion and a determining portion of presence of data, various kinds of keys 9 for operating the present video camera, a graphic circuit 10 for producing various kinds of pictures, such as, piling up or superposing character information, etc., for example, and a display portion 11 of a liquid crystal panel or the like. The card 5 and the disk 4 may be sometimes called a recording medium or a recording portion, collectively.

When recording, an image of an object (or a target), which is captured through the lens 1, is converted into a video signal on the CCD 2, passes through the camera DSP 3, and further, after being treated with the processes, such as, compression, etc., within the recording/reproducing circuit 7, it is recorded onto the disk 4 through the interface 6. On the other hand, digital video signal, which is inputted into the recording/reproducing circuit 7, is displayed on the display portion 11, being superposed with the character information or the like thereon, within the graphic circuit 10.

Herein, when recording a moving picture, it is assumed that data is compressed to MPEG moving picture data of (horizontal) 720 pixels×(vertical) 480 pixels of the MPEG format of a moving picture compression format, as a first compression/expansion method, within the recording/reproducing circuit 7, and recorded on the disk 4 through the interface 6. In this instance, information is also recorded on the disk 4, that the MPEG data recorded is the moving picture.

Also, when recording a still picture, it is assumed that compression is made from still picture data of (horizontal) 1,600 pixels×(vertical) 1,200 pixels of high resolution to JPEG still picture data, and also the still picture data is newly produced from the still picture data by reducing the still picture data of (horizontal) 1,600 pixels×(vertical) 1,200 pixels before compression into the JPEG still picture data down to (horizontal) 720 pixels×(vertical) 480 pixels, thereby compressing into MPEG-I still picture data.

The pixel numbers should not be restricted to those. Although two (2) pieces of different still picture data are produced, however one is larger than the other, in the pixel number thereof. The JPEG still picture data and the MPEG-I still picture data are related to each other, and are recorded onto the disk 4 together with management information, through the interface 6. In this instance, information is also recorded on the disk 4, that the MPEG-I data recorded is the still picture.

As an example of establishing a relationship between the JPEG still picture data and the MPEG-I still picture data, the relation is made by date/time when recoding, the relation is made by a file name, or attaching a common number to the files, and so on. However, in case when establishing the relationship by using the file name, because of a possibility of editing the name by a user, it is preferable to adopt a method or format other than that of using the name that may be edited by the user.

Also, production of the MPEG-I still picture data may be executed, not only when recording the still picture, but also when finalizing, such as, when receiving an instruction from various kinds of keys 9 or when the disk 4 is a DVD-R, etc., with the MPEG format, for example.

When reproducing, the MPEG moving picture data and the MPEG-I still picture data, after being processed with decoding (expansion), etc., within the recording/reproducing circuit 7 through the interface 6, are superposed with character information within the graphic circuit 10, thereby to be displayed on the display portion 11. Or, it is also possible to display thumbnail pictures of the MPEG moving picture data and the MPEG-I still picture data, so as to select the picture to be reproduced from those thumbnail pictures.

Herein, when reproducing the moving picture, the MPEG moving picture data is decoded within the recording/reproducing circuit 7 through the interface 6, and it is displayed on the display portion 11 through the graphic circuit 10. Also, when reproducing the still picture, the MPEG-I still picture data recorded on the disk 4 is decoded within the recording/reproducing circuit 7 through the interface 6, in accordance the MPEG format, to be displayed on the display portion 11 through the graphic circuit 10.

The microcomputer 8 builds up a controller portion for controlling the entire of the present video camera. Thus, it controls each block, in accordance with an input from the various kinds of keys 9, and comprises a still picture capturing portion for capturing a still picture therein, arbitrarily, during when reproducing the MPEG moving picture data or the MPEG-I still picture data recorded on the disk 4, thereby recording it into the card 5, and a data presence determining portion for determining on whether there is JPEG still picture data or not, which is related with the MPEG moving picture data or the MPEG-I still picture data under reproduction. Within the present embodiment, explanation was made each software is executed by the CPU, but it may be executed by a hardware.

Brief explanation will be made the operations when executing the still picture capturing operation. When instructed is made on reproduction, with a predetermined operation from the various kinds of keys 9, then the microcomputer 8 decodes (or expands) the MPEG moving picture or the MPEG-I still picture data recorded on the disk 4, within the recording/reproducing circuit 7 through the interface 6, in accordance with the MPEG method (format), and displays a picture reproduced on the display portion 11 through the graphic circuit 10. When detecting depression of the still picture capture button (i.e., a gain instruction) among the various kinds of keys 9, the microcomputer 8 is in the condition of stopping or pausing the reproduction and displays the picture, which is reproduced at that time, on the display portion 11. Thereafter, the microcomputer 8 makes determination, by means of the data presence determining portion thereof, on the presence of JPEG still picture data related to the MPEG moving picture data or the MPEG-I still picture data, which is an original of the picture displayed.

In case when determining that there is the JPEG still picture data related by the data presence determining portion, the JPEG still picture data related to the picture on the display is read out by means of the still picture capturing portion of the microcomputer 8, and that JPEG still picture data is recorded into the card 5 through the interface 6. Herein, since there is the JPEG still picture data for the MPEG-I still picture data, then the still picture to be captured for recording during the reproduction of still picture is the still picture data of (horizontal) 1,600 pixels×(vertical) 1,200 pixels, which is recorded with the original JPEG method (format); therefore, it is possible to make an improvement of the picture quality of the still picture, which is to be captured for recording during the reproduction of still picture.

Also, in case when determining that there is no JPEG still picture data related by the data presence determining portion, the microcomputer 8 reads out the MPEG moving picture data on the disk, which is the original data of the picture on display, by means of the still picture capturing portion thereof, and converts it into the JPEG still picture data within the recording/reproducing portion 7 to be recorded into the card 5 through the interface 6. With this, during the reproduction of the moving picture, it is possible to obtain the still picture, which is re-compressed from the MPEG format into the JPEG format.

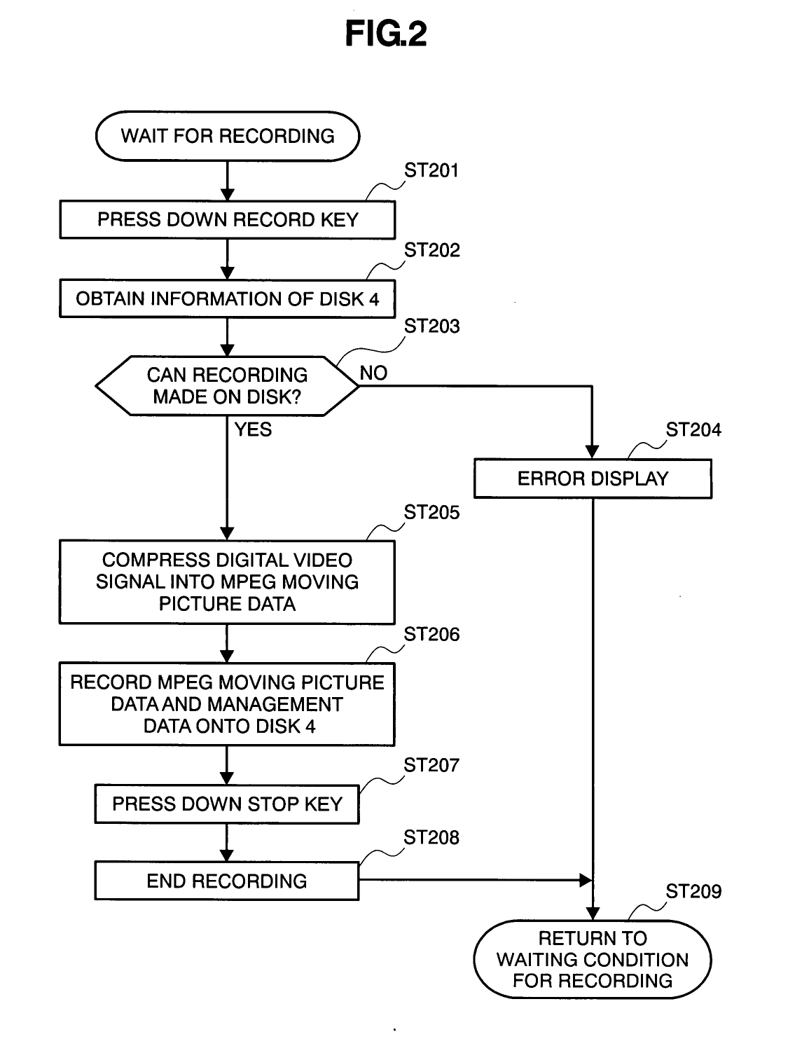

(2) Detailed description will be made on recording and reproducing of the moving picture and the still picture of the video camera, by referring to FIGS. 2 to 5.

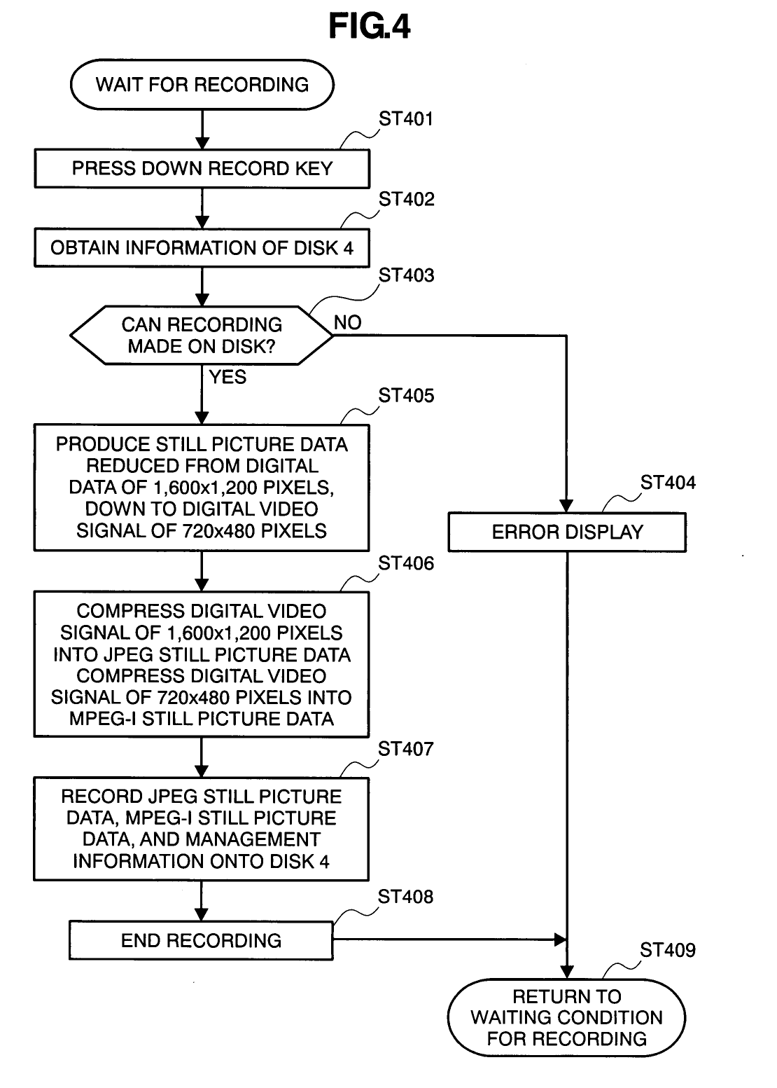

First of all, explanation will be made on the recording operation by referring to FIGS. 2 and 4.

FIG. 2 is a flowchart for showing an example of operation of the video camera when recording the moving picture. Under the condition of waiting for recording, when a record key is depressed among the various kinds of keys 9, so as to start the recording operation (ST201), information is obtained about the disk 4, being the recording medium at the destination of recording (ST202), to determine on whether it can be recorded on the disk or not (ST203).

In case where it cannot be recorded on the disk 4 (“No” in ST203), error display is made (ST204), and the operation turns back to the condition of waiting for recording (ST209). In case where it can be recorded on the disk 4 (“Yes” in ST203), the digital video signal is compressed into the MPEG moving picture data of (horizontal) 1,600 pixels×(vertical) 1,200 pixels (ST205), and that MPEG moving picture data and the management data thereof are recorded onto the disk (ST206). When a stop or pause key is depressed among the various kinds of keys 9 (ST207), it comes into an end of recording (ST208) and turns back to the condition of waiting for recording (ST209).

FIG. 4 is a flowchart for showing the operations when the video camera records the still picture. Under the waiting condition for recording, it conducts a recording start operation (ST401), upon pressing-down of the record key among the various kinds of keys 9. Obtaining information of the disk 4 (ST402), being the recording medium at the destination of recording, it is determined on whether recording can be made or not on that disk (ST403). In case when recording cannot be made on that disk (“No” in ST403), an error display is made (ST404), and then the operation turns back to the waiting for recording (ST410). In case when recording can be made on that disk (“Yes” in ST403), within the recording/reproducing circuit 7 is newly produced still picture data, which is reduced from the pixels of high dissolution of the digital video signal, i.e., (horizontal) 1,600 pixels×(vertical) 1,200 pixels, down to (horizontal) 720 pixels×(vertical) 480 pixels (ST405). The still picture data of (horizontal) 1,600 pixels×(vertical) 1,200 pixels is compressed into the JPEG still picture data, and the still picture data of (horizontal) 720 pixels×(vertical) 480 pixels is compressed into the MPEG-I still picture data (ST406). The JPEG still picture data and the MPEG-I still picture data are related to each other, and they are recorded on the disk 4, together with management information (ST407). When completing the recording, the video cameral automatically falls into an end of recording (ST408), i.e., it turns back into the condition of waiting for recording (ST409).

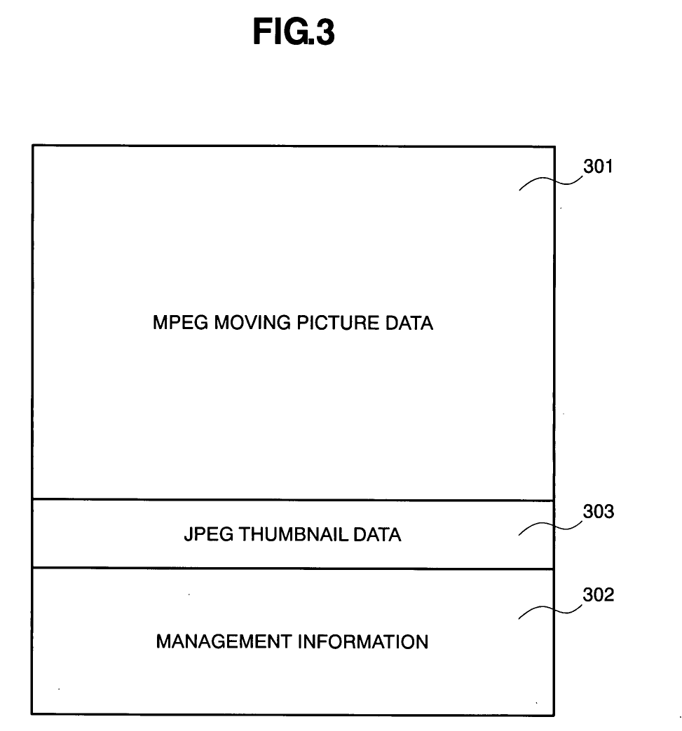

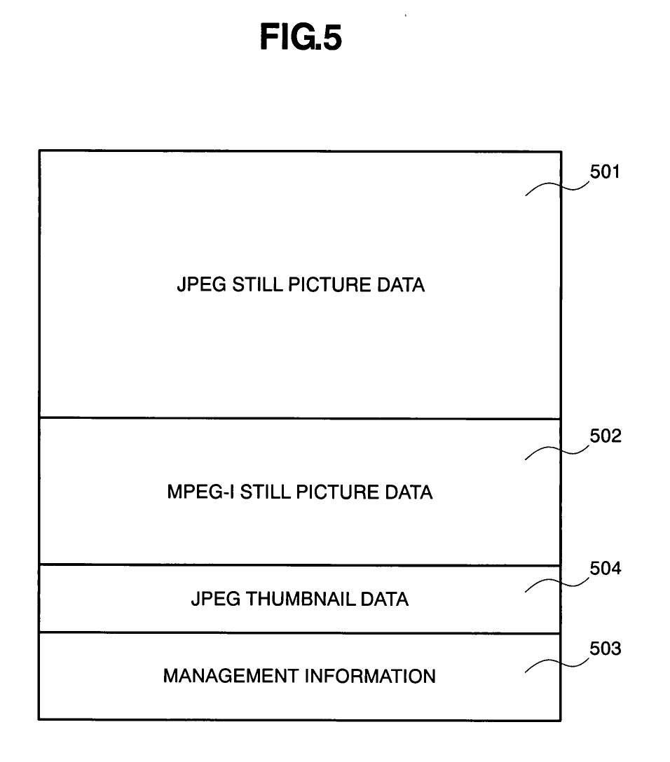

Explanation will be made on the data configuration or structures of the data, which are recorded on the disk 4 through the recording operation mentioned above, by referring to FIGS. 3 and 5.

FIG. 3 shows an example of the data configuration when recording the moving picture by the video camera. The MPEG moving picture, recording the moving picture therein, is built up with MPEG moving picture data 301, being compressed with the MPEG format, and management information 302, which is prepared for managing that data. When reproducing, the MPEG moving picture 301 is read out upon basis of the management information 302, to be reproduced. Also, a thumbnail picture 303 is stored, which is obtained by reducing the “I” picture of the MPEG moving picture. Herein, it is assumed that the format of the thumbnail is the JPEG.

FIG. 5 shows an example of the data configuration when recording the still picture by the video camera. The JPEG still and the MPEG-I still picture data, recording the still picture therein, is built up with JPEG still picture data 501 compressed with the JPEG format and MPEG-I still picture data 502 and management information 503 prepared for managing those data. The fact is recorded into the management information 503 that the MPEG-I still picture data 502 is related to the JPEG still picture data 501. When reproducing, the MPEG-I still picture data is reproduced upon basis of the management information 503, also the JPEG still picture data 501 related to the MPEG-I still picture data is read out when the still picture capturing function is operated, and then they are recorded into the card 5. A thumbnail picture 504 is also memorized therein, which is obtained by reducing the MPEG-I still picture data or the JPEG still picture data. Herein, it is also assumed that the format of the thumbnail is the JPEG. For make distinction between the JPEG still picture data 501 and the JPEG thumbnail picture 504, also the former may be called “high pixel number picture”, the latter “reduced picture”. In this instance, the MPEG-I still picture is called “low pixel number picture”.

Further, for example, the inner configuration (i.e., folder configuration) when recording the still picture and the moving picture on the DVD-RAM has DCIM, DVD_RTAV, and RTR_EXTN. Into the DCIM is recorded the JPEG still picture (high pixel number picture). Into the DVD_RTAV are recoded the MPEG moving picture and the MPEG-I still data, respectively, separating from each other. Into the RTR_EXTN is recorded the JPEG thumbnail. Each of those DCIM, DVD_RTAV, and RTR_EXTN has it's own management information. Herein, for example, the relationship between the JPEG still picture (high pixel number picture) and the MPEG-I still data may be written, preferably into the management information of DVD_RTAV. Or, it may be written into other management information (such as, the management information of DCIM).

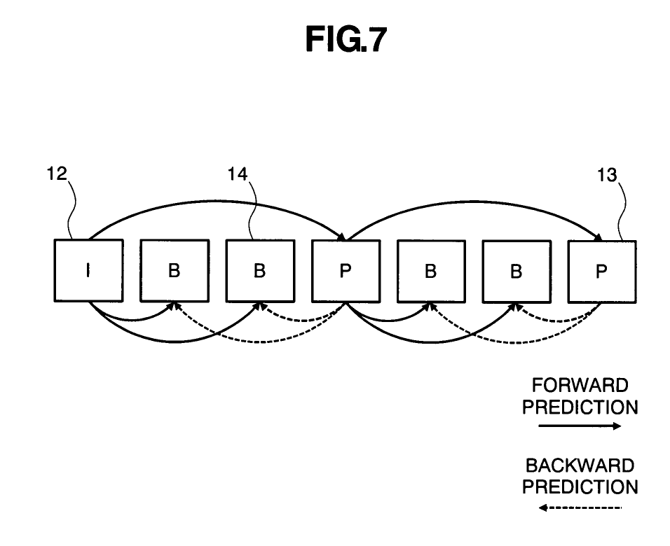

(3) Details of the still picture capturing function of the vide camera will be explained, by referring to FIGS. 7 to 9. Herein, it is assumed that the still picture capturing function is the function of capturing or taking a desired still picture, from among the moving pictures under reproduction or the still pictures, which are supplied to the display portion 11 to be displayed thereon, into the card 5. Although it is shown that the data of the still picture on the disk 4, i.e., the first recording medium, is captured into the card 5, i.e., the second recording medium, however the data on the disk 4, i.e., the first recording medium, may be recorded as it is onto the disk 4, i.e., the first recording medium.

FIG. 7 shows a series of flows of predictive coding within the MPEG compression method or format. A reference numeral 12 depicts the MPEG-I picture, i.e., the video data, which is produced by compressing the data within the frame. A reference numeral 13 depicts MPEG-P picture, i.e., the video data being produced upon changes obtained from the MPEG-I picture or MPEG-P picture, which was produced previously in point of time. A reference numeral 14 depicts a MPEG-B picture, i.e., the vide data being produced upon prediction from the pictures reproduced on both front and back thereof. On the disk 4 recording the moving picture and the still picture with the MPEG method or format, in order to capture or take in the still picture, to be recorded, from this series of flows of coding, searching is made upon the MPEG-I picture, which is near to the timing when pushing down the still picture capture button, among continuous MPEG streams, in case where the still picture capture button is pushed down, and it is taken out to be convert it into the JPEG still picture data to be recorded into the card 5.

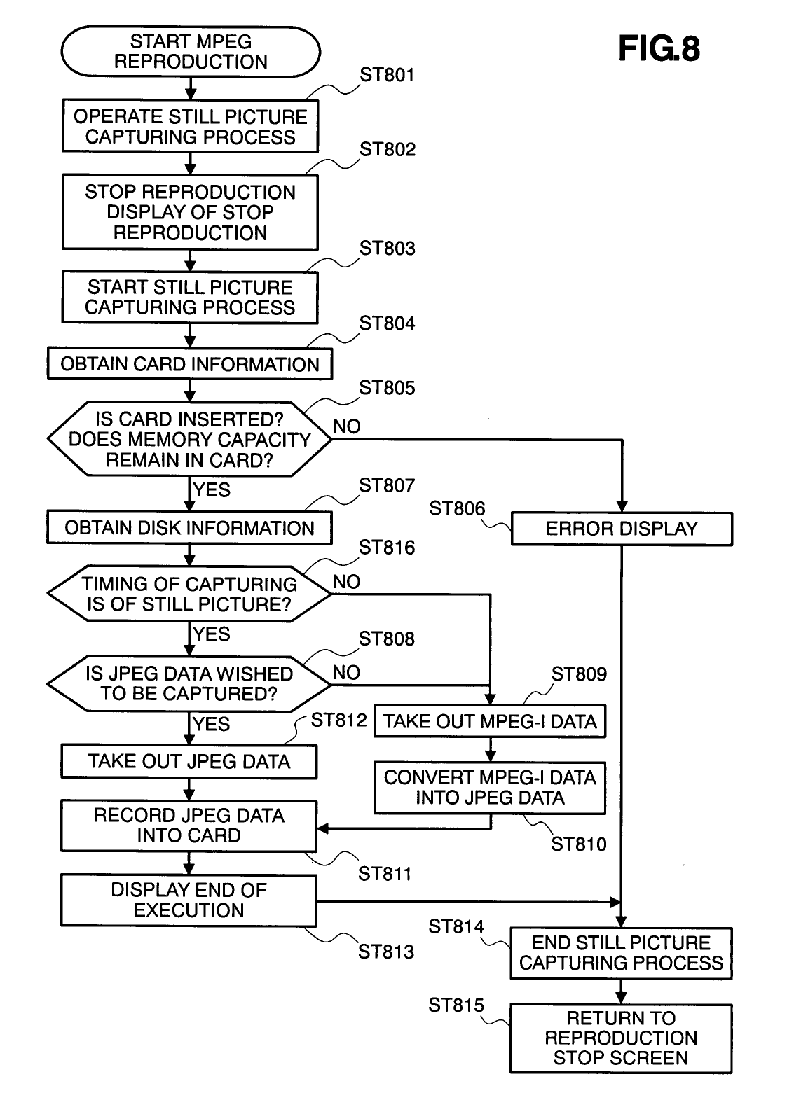

FIG. 8 is a flowchart for showing an example of processes when the still picture capturing (obtaining) function operates of the video camera. When conducting the operation processes of the still picture capturing function (ST801), through the still picture capture button within the various kinds of keys 9 or the like, during the time when reproducing the MPEG moving picture data and/or the MPEG-I still picture data on the disk 4 with the MPEG format, then the camera is in the condition of stopping the reproduction, thereby displaying the still picture at that time (ST802) as a reproduction stop screen, and also starting the still picture capturing process (ST803). Herein, for example, in case when setup is made that MPEG moving picture data A, MPEG-I still picture data B, MPEG moving picture data C and MPEG still picture data D are recorded or to be reproduced, in that time series, reproduction will be made according to that. Such condition is called “reproduced mixed with” or “reproduced without distinction”. Thus, “mixing with” or “without distinction” does not means that, for example, the MPEG moving picture data A and the MPEG-I still picture data B are displayed at the same time. On the contrary, in case when setup is made that the MPEG moving picture data A, the MPEG-I still picture data B, the MPEG moving picture data C and the MPEG still picture data D are recorded or to be reproduced, in that time series, displaying the MPEG moving picture data A and the MPEG moving picture data C or the MPEG-I still picture data B and the MPEG still picture data D, in this way, positively, is called “reproduced with distinction”.

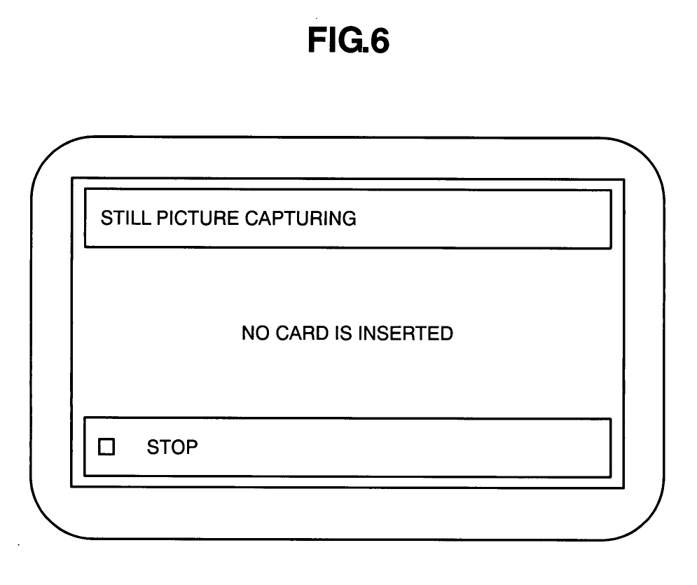

After starting the still picture capturing process, information of the card 5 is obtained, to be recorded by the microcomputer 8 (ST804), and determination is made on whether the card 5 is recordable or not, through checking made upon basis of information, including the presence of the card 5, a remaining memory volume thereof, etc. (ST805). In case where it is un-recordable (“No” in ST805), such a message error, as shown in FIG. 6, is displayed on the display portion 11 (ST806), and the still picture capturing process is ended (ST814). Then, it turns back to the reproduction stop screen, thereby displaying the still picture at that time as that reproduction stop screen (ST815).

FIG. 6 shows an example of the error display in the ST806 shown in FIG. 8. There is displayed a message, such as, “No Card is Inserted”, for example, as shown in FIG. 6. Herein, seeing this display, a user may insert a card, or replace it with a card having sufficient memory capacity.

In case where it is recordable (“Yes” in ST805), the management information on the disk 4 is obtained by the microcomputer 8 through the interface 6 (ST807). Within the data presence determining portion of the microcomputer 8 is made determination on the presence, i.e., on whether there is the MPEG moving picture data or not, being the original data of the still picture, which is supplied to the display portion 11 to be displayed thereon, or there is the JPEG still picture data or not, being related to the MPEG-I still picture data (ST816, ST808). Explanation will be given in more details of the method for determination. When the still picture capturing process is operated during when the reproduction is conducted with the MPEG format, a still picture is displayed, while turning the reproduction into the stop condition (i.e., the reproduction stop condition), and then determination is made by the microcomputer 8, on whether it is the MPEG moving picture data or the MPEG-I still picture data (ST816), upon basis of the information recorded when recording the moving picture and the still picture.

When it is determined to be the MPEG-I still picture data, then search is made on the presence of the JPEG still picture related thereto, upon the management information related with when recoding the still picture (ST808). In case when there is no JPEG still picture data related thereto (“No” in ST808), or in case when there is only the MPEG moving picture data for the still picture displayed (“No” in ST816), in accordance with the control of the still picture capturing portion of the microcomputer 8, the recording/reproducing circuit 7 takes out the MPEG-I picture from the MPEG moving picture data (ST809). After converting the MPEG-I picture captured into the JPEG still pictured data (ST810), it is recorded into the cared 5 (ST811). An execution end message is displayed on the display portion 11 (ST813) by means of the microcomputer 8, thereby ending the still picture capturing process (ST814), and the display turns back to the reproduction stop screen, so as to display the still picture at that time to be that production sop screen (ST815).

In case when there is the JPEG still picture data related to the MPEG-I still picture data for the still picture, which is supplied to the display portion 11 to be displayed therein (“Yes” in ST808), then the related JPEG still picture data on the disk 4 is taken out through the interface 6 (ST812). The JPEG still picture data taken out is recorded into the card 5 (ST811). By means of the microcomputer 8, the execution end message is displayed on the display portion 11 (ST813), thereby ending the still picture capturing process (ST814), and the display turns back to the reproduction stop screen, so as to display the still picture at that time to be that production sop screen (ST815).

However, in case when capturing the still picture data of EMPEG format, always, with converting into the still picture of JPEG, through the still picture capturing function from the data of MPEG format under reproduction (irrespective of the moving picture or the still picture), within the flowchart shown in FIG. 8, steps TS807, TS808 and TS812 are omitted, and in case when “Yes” in ST805, it is enough to connect the step with ST809. Thus, in case where the recording is able (“Yes” in ST805), the MPEG moving picture data or the MPEG-I still picture data on display is taken out from the disk, i.e., the origin of reproduction (ST809), and after converting being converted into the JPEG still picture data (ST810), it is recorded into the recording medium, i.e., destination of recording (ST811). However, in this instance, if the timing, when receiving an operation instruction from a user to be a scene that she/he wishes to capture and record in the form of the still picture, is under the reproduction of the still picture, the original data to be taken in through the still picture capturing function is the still picture data, which is recorded with the MPEG format ((horizontal) 720 pixels×(vertical) 480 pixels). In case when converting this into the still picture data of the JPEG format, it comes to be the data of the pixels, i.e., (horizontal) 720 pixels×(vertical) 480 pixels. Therefore, it means that the still picture data, being lower in the pixel number, (horizontal) 1,600 pixels×(vertical) 1,200 pixels, which are originally recorded with the JPEG format, is taken into through the still picture capturing function. Judging from the user, if taking in or capturing the pictures through the still picture capturing function, even though they are the still pictures photographing the same scene (i.e., they look to be same for the user, irrespective of picture quality thereof, even with the JPEG format or the MPEG format), there is a possibility that the user feels the picture quality is lowered than the still picture obtained when photographing. On the other hand, according to the present embodiment, such the drawback is already dissolved as was mentioned.

While we have shown and described several embodiments in accordance with our invention, it should be understood that disclosed embodiments are susceptible of changes and modifications without departing from the scope of the invention. Therefore, we don not intend to be bound by the details shown and described herein but intend to cover all such changes and modifications that fall within the ambit of the appended claims.

What is claimed is:

1. An image processing apparatus, comprising:
a reproducing portion, which is configured to reproduce a picture compressed with a first format;
an obtain instructing portion, which is configured to instruct an obtaining of the picture reproduced by said reproducing portion; and
a recording portion, which is configured to record the picture, obtaining of which is instructed by said instructing portion, wherein
said recording portion determines on presence of a picture, which is compressed with a second format corresponding to the picture instructed by said instructing portion, and wherein it records said picture corresponding thereto, which is compressed with said second format, when determining it is, or records said picture instructed, by compressing it with said second format, when determining it is not.

2. The image processing apparatus, as is described in the claim 1, wherein
said reproducing portion reproduces the picture from a first recording medium, and
said recording portion records the picture onto a second recording medium differing from said first recording medium.

3. The image processing apparatus, as is described in the claim 1, wherein
said reproducing portion reproduces a moving picture and a still picture,
said recording portion compresses a still picture with said second format, to be recorded, fitting to one scene of the moving picture instructed when said one scene is instructed on the moving picture by said instructing portion, or determines on presence of the picture, which is compressed with said second format corresponding to the still picture instructed by said instructing portion, when the still picture is instructed by said instructing portion.

4. The image processing apparatus, as is described in the claim 1, wherein
the picture compressed with said second format corresponding thereto is high in a pixel number thereof than that of said picture, which is instructed by said instructing portion.

5. The image processing apparatus, as is described in the claim 1, wherein
said first format is MPEG format, and
said second format is JPEG format.

6. The image processing apparatus, as is described in the claim 1, further comprising:
a reduced picture displaying portion, which is configured to display a reduced picture compressed with said first format; and
a reproduction instruction portion, which is configured to instruct a picture to be reproduced within said reproducing portion from the reproduced picture, which is displayed on said reduced picture displaying portion.

7. An image processing method, comprising the following steps of:
reproducing a picture, which is compressed with a first format;
receiving an instructing for obtaining of the picture under reproduction;
determining presence of the picture, which is compressed with a second format, corresponding to the picture receiving the instruction for obtaining thereof; and
recording said picture corresponding thereto, which is compressed with said second format, when determining there is, when determining it is, or
Recording said picture instructed, by compressing it with said second format, when determining it is not.

8. The image processing method, as described in the claim 7, wherein
when the picture receiving the instruction of obtaining is one scene of a moving picture, a still picture fitting to said instructed one scene of the moving picture is recorded by compressing it with said second format.

9. The image processing method, as described in the claim 7, wherein there are provided:
a reduced picture displaying portion, which is configured to display a reduced picture compressed with said first format; and
a reproduction instruction portion, which is configured to instruct a picture to be reproduced within said reproducing portion from the reproduced picture, which is displayed on said reduced picture displaying portion.

10. An image processing apparatus, comprising:
a reproducing portion, which is configured to reproduce a picture;
a capture instructing portion, which is configured to instruct capturing of a picture under reproduction within said reproducing portion; and
a recording portion, which is configured to record a picture, being higher in a pixel number than the picture, capturing of which is instructed by said capture instructing portion.
